(19) United States
(12) Patent Application Publication
(10) Pub. No.: US 2025/0272885 A1
(43) Pub. Date: Aug. 28, 2025

(54) SELF ATTENTION REFERENCE FOR IMPROVED DIFFUSION PERSONALIZATION

(71) Applicant: ADOBE INC., SAN JOSE, CA (US)

(72) Inventors: Nicholas Isaac Kolkin, Chicago, IL (US); Aashish Kumar Misraa, Santa Clara, CA (US); Midhun Harikumar, Sunnyvale, CA (US); Elya Shechtman, Seattle, WA (US)

(21) Appl. No.: 18/817,915

(22) Filed: Aug. 28, 2024

Related U.S. Application Data
(60) Provisional application No. 63/558,365, filed on Feb. 27, 2024.

(51) Int. Cl. G06T 11/00; G06V 10/774; G06V 10/82

(52) U.S. Cl. CPC G06T 11/00; G06V 10/774; G06V 10/82

(57) ABSTRACT

A method, apparatus, non-transitory computer readable medium, and system for image processing include obtaining a reference image an input prompt describing an image element, identifying an object from the reference image; generating, using an image generation model, image features representing the object based on the reference image, and generating, using the image generation model, a synthetic image depicting the image element and the object based on the input prompt and the image features from the reference image.

### CROSS-REFERENCE TO RELATED APPLICATION

This application claims priority under 35 U.S.C. § 119 to U.S. Provisional Application No. 63/558,365, filed on Feb. 27, 2024, in the United States Patent and Trademark Office, the disclosure of which is incorporated by reference herein in its entirety.

### BACKGROUND

The following relates generally to image processing, and more specifically to image processing using a machine learning model. Image processing refers to the use of a computer to edit an image using an algorithm or a processing network. In some cases, image processing software can be used for various image processing tasks such as image restoration, image detection, image compositing, image editing, and image generation. For example, image generation includes the use of the machine learning model to generate an image based on an input such as a text prompt or a reference image.

Image generation refers to generating a synthetic image based on one or more inputs such as a reference image or a text prompt. Image generation is useful in generating new images that have features that are aligned with the inputs. However, conventional models do not generate and integrate specific target details.

### SUMMARY

Aspects of the present disclosure provide a method and system for personalizing an image generation model. According to some aspects, the system receives a text prompt and a reference image depicting an object to generate a synthetic image that depicts the object. In one aspect, an image generation model is used to generate image features including detailed information of the object based on the reference image. The image features are input into one or more attention layers of the U-Net architecture of the image generation model to guide the image generation model to generate the synthetic image.

A method, apparatus, non-transitory computer readable medium, and system for image processing include obtaining a reference image an input prompt describing an image element; identifying an object from the reference image; generating, using an image generation model, image features representing the object based on the reference image; and generating, using the image generation model, a synthetic image depicting the image element and the object based on the input prompt and the image features from the reference image.

A method, apparatus, non-transitory computer readable medium, and system for training a machine learning model include obtaining a training set including a reference image depicting an object, an input prompt describing an image element, and a ground-truth image depicting the object and the image element, and training, using the training set, the image generation model to generate image features for the object based on the reference image and to generate a synthetic image depicting the object based on the input prompt and the image features.

An apparatus and system for image processing include at least one processor, at least one memory storing instructions executable by the at least one processor, and an image generation model comprising parameters stored in the at least one memory and trained to generate image features for an object depicted in a reference image and to generate a synthetic image depicting the object based on an input prompt and the image features, where the image generation model receives the image features via at least one attention layer.

### BRIEF DESCRIPTION OF THE DRAWINGS

FIG. 1 shows an example of an image processing system according to aspects of the present disclosure.

FIG. 2 shows an example of a method for generating a synthetic image according to aspects of the present disclosure.

FIG. 3 shows an example of text-to-image generation according to aspects of the present disclosure.

FIG. 4 shows an example of a method for generating a synthetic image according to aspects of the present disclosure.

FIG. 5 shows an example of an image processing apparatus according to aspects of the present disclosure.

FIG. 6 shows an example of a machine learning model according to aspects of the present disclosure.

FIG. 7 shows an example of an image generation model according to aspects of the present disclosure.

FIG. 8 shows an example of a U-Net according to aspects of the present disclosure.

FIG. 9 shows an example of data flow in an image processing system according to aspects of the present disclosure.

FIG. 10 shows an example of a method for image processing according to aspects of the present disclosure.

FIG. 11 shows an example of a computing device according to aspects of the present disclosure.

### DETAILED DESCRIPTION

Aspects of the present disclosure relate to image generation using generative machine learning model. Some embodiments of the disclosure relate to an image generation system that accurately generates synthetic images that include the same visual elements from an object depicted in a reference image. In one aspect, an image generation model is trained to generate image features that includes visual information of the object depicted in the reference image. The image features are provided back to the decoding layers of the image generation model and are combined with the features of the text prompt to ensure that the same visual elements of the object from the reference image is accurately generated in the synthetic image along with additional elements described by the text prompt.

According to some embodiments, the system generates an object mask based on the reference image. In some cases, the system uses a mask generation network to identify one or more visually interesting regions (that aligns with the object described in the text prompt) in the reference image and labels the regions white. The remaining background region is labeled black. In one aspect, the black-and-white object mask is used as an input to the image generation model to generate the image features. In one aspect, the image features include detailed visual information of the object depicted in the reference image. By using an object mask to generate the image features, the image generation model can generate image features having less or no noisy information (e.g., the visual information of the background region of the reference image is excluded).

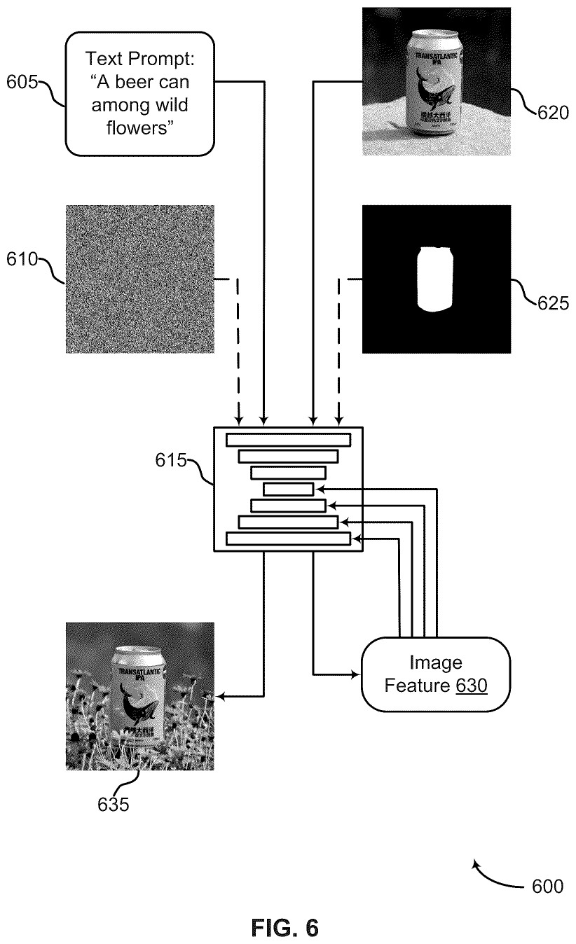

In one aspect, the text prompt describes a relation between an object and a background scene, and the reference image depicts the object. In one aspect, the object depicted in the synthetic image includes the same fine visual details from the object depicted in the reference image. For example, when the reference image depicts a beer can with complicated foreign words/characters (as shown in FIG. 6), the image generation model is able to generate the synthetic image having the same visual details of the beer can (i.e., the same complicated foreign words/characters). In some aspects, the image generation model generates one or more image features based on the reference image, and the one or more image features are added to one or more attention layers in the decoding layers of the U-Net architecture of the image generation model. Accordingly, the image quality of the synthetic image is improved.

A subfield in image processing relates to image generation. For example, conventional image generation models receive input conditions such as text, image, and color to generate a synthetic image. Some models receive a text prompt that describes a background scene and a reference image that includes an object to generate an output image depicting the object in the background scene. However, these models are unable to accurately generate the visual features of the object. For example, these models generate synthetic images based on the image feature of the reference image during inference time without training the image generation model to adopt the new features from the image feature. As a result, fine details from the reference image cannot be properly transferred and depicted in the generated synthetic image.

In some cases, some systems use a pre-trained image encoder to generate an image embedding that captures information of the reference image. For example, the image embedding is a high-dimensional vector that encodes semantic information and contents of the reference image. Then, the systems use an image generation model to generate the synthetic image based on the image embedding. However, this technique raises several issues. For example, when encoding the semantic information, the image embedding can lose spatial relationships and fine-grained details presented in the reference image. For example, due to the compact nature of the image embedding, the image embedding might not capture the intricate details of the reference image. As a result, image embeddings are less suitable for tasks such as high-fidelity image synthesis.

Accordingly, embodiments of the disclosure improve on conventional image generations models by accurately generating synthetic images depicting an object having the same visual content in an object from a reference image. This is achieved using an image generation model that is trained to generate image features of an object from a reference image and combine the image features to the features of the text prompt to generate the synthetic image. Image features include a more accurate information of the visual elements than an image embedding. For example, image features maintain the spatial structure and preserve high levels of detail and resolution of the object depicted in the reference image.

In some embodiments, the system identifies the object depicted in the reference image using an object mask. For example, the system includes a mask generation network that identifies a visually interesting region (i.e., the object) and generates the object mask indicating the location of the object within the reference image. By generating the one or more image features based on the reference image and the object mask, the one or more image features include information (such as visual features) of the object and not visual features of the background of the reference image. Accordingly, the image features include less or no noisy information about the object, and thus, the image quality of the object depicted in the synthetic image is enhanced.

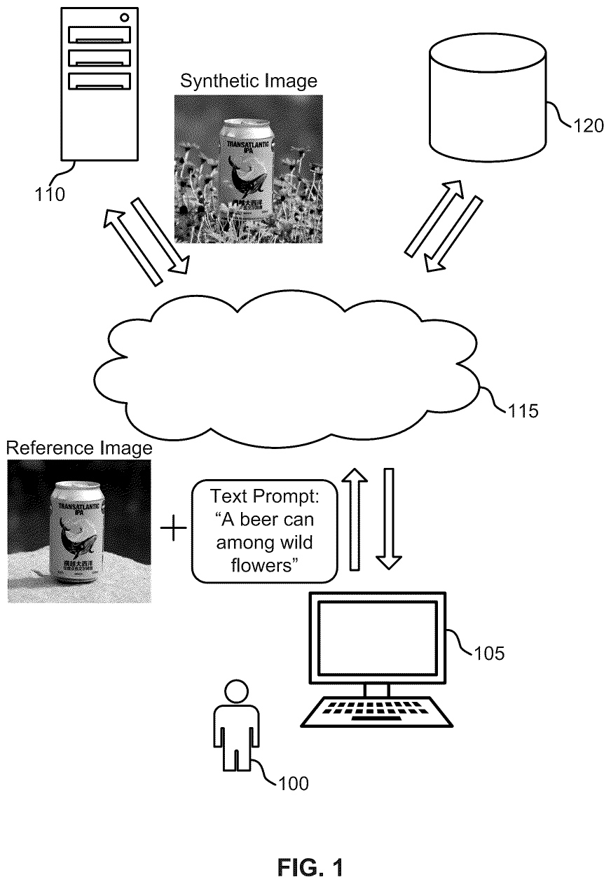

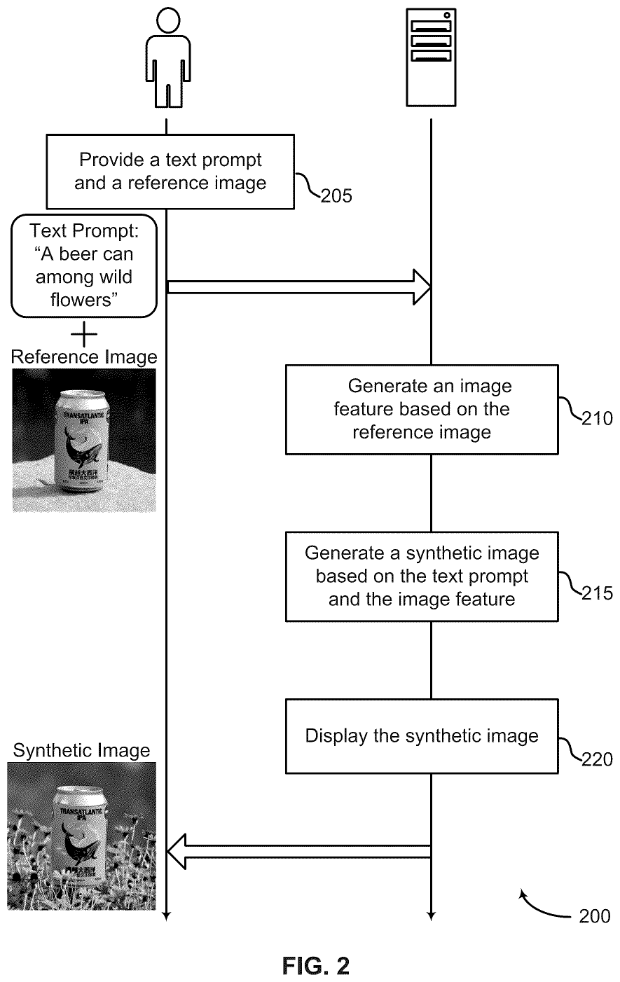

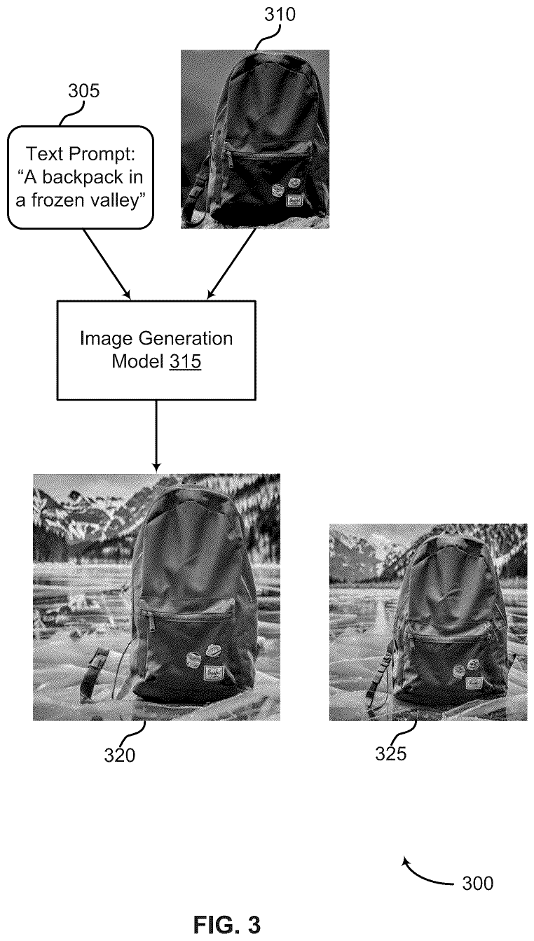

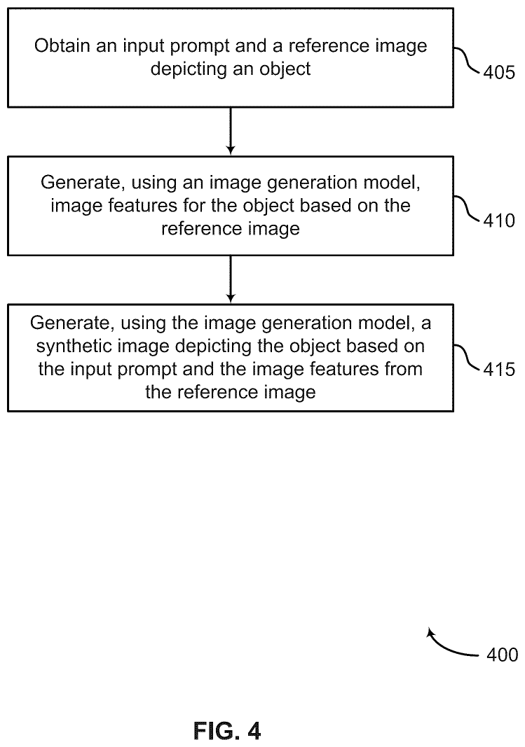

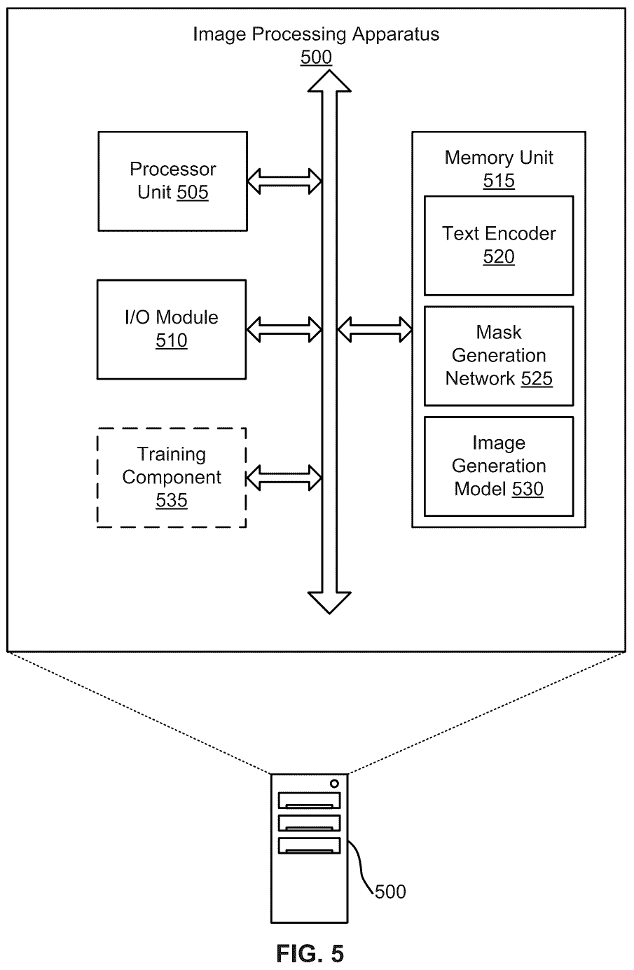

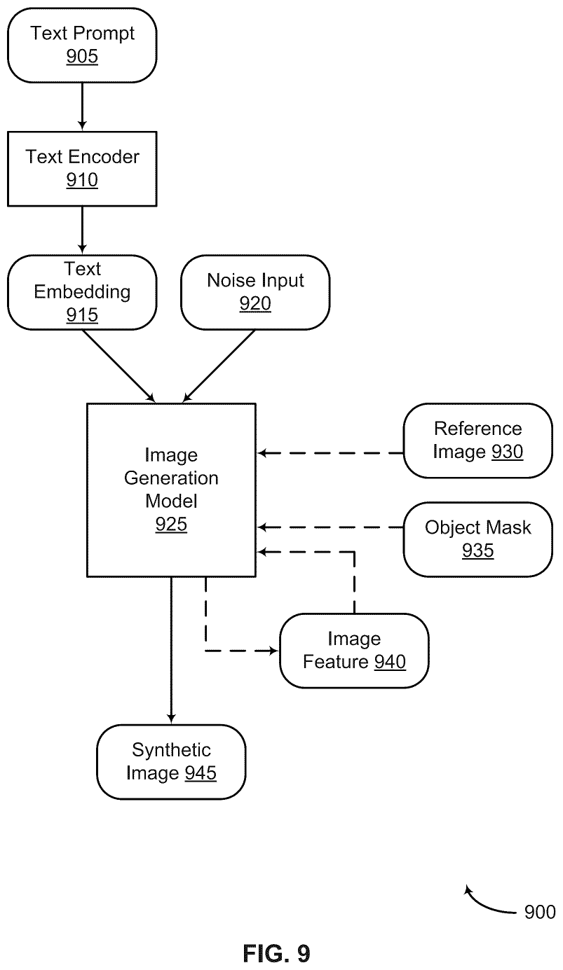

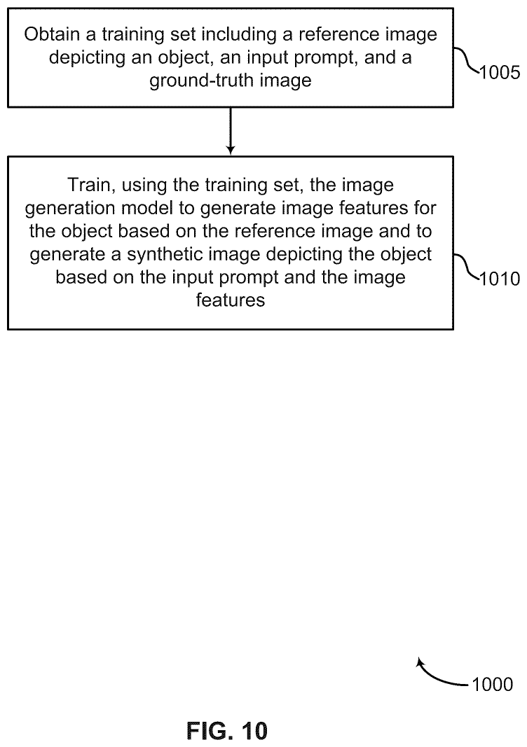

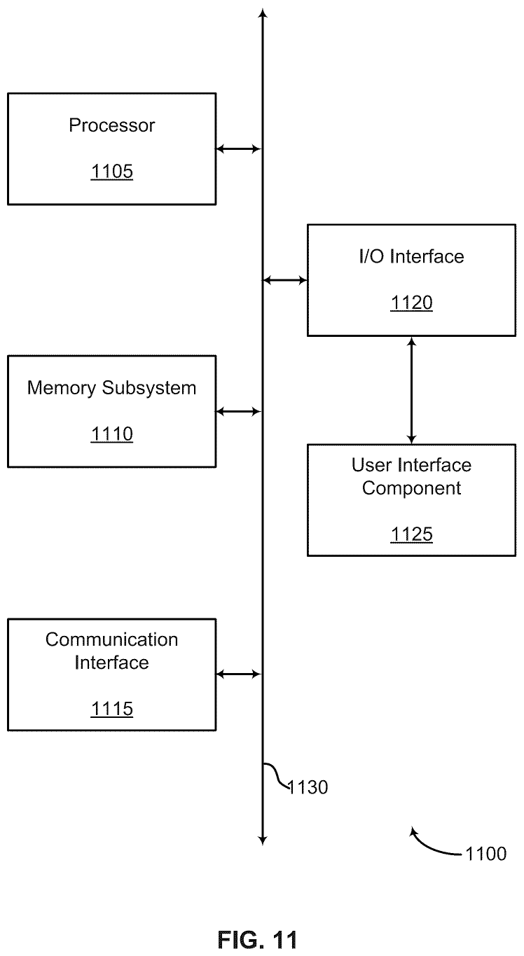

An example system of the inventive concept in image processing is provided with reference to FIGS. 1 and 11. An example application of the inventive concept in image processing is provided with reference to FIGS. 2-3. Details regarding the architecture of an image processing apparatus are provided with reference to FIGS. 5-8. An example of a process for image processing is provided with reference to FIGS. 4 and 9. A description of an example training process is provided with reference to FIG. 10.

Embodiments of the present disclosure include systems and methods that improve on conventional image generation models by accurately generating synthetic images depicting an object based on a reference image that includes the object. For example, the synthetic image depicts the object (including the same visual details) from the reference images in a new background scene (e.g., described by a text prompt). For example, the synthetic images maintain the integrity of the object better than the output images generated by the conventional image generation models. In some embodiments, an image generation model is trained to generate image features based on an object depicted in the reference image. By combining the image features to the features representing the text prompt in the corresponding attention layers, the image generation model can preserve the same visual detail of the object from the reference image in the synthetic image.

In some embodiments, by using the attention layers of the U-Net architecture of the image generation model to generate the image features from the reference image, the model can selectively attend to important regions of the reference image thus reducing computational demand. In some embodiments, the image generation model is trained using the reference image, and the image generation model is able to adopt the new features. Accordingly, fine details from the reference image can be accurately depicted in the generated synthetic image.

### Image Processing

In FIGS. 1-4, and 9, a method, apparatus, non-transitory computer readable medium, and system for image processing are described. The method, apparatus, non-transitory computer readable medium, and system include obtaining an input prompt and a reference image depicting an object, generating, using an image generation model, image features for the object based on the reference image, and generating, using the image generation model, a synthetic image depicting the object based on the input prompt and the image features from the reference image.

In some aspects, the reference image depicts the object in a first scene and the synthetic image depicts the object in a second scene described by the input prompt. Some examples of the method, apparatus, non-transitory computer readable medium, and system further include generating an object mask that indicates the location of the object in the reference image, where the image features are generated based on the object mask. In some aspects, the image features are conditioned based on a diffusion time step.

Some examples of the method, apparatus, non-transitory computer readable medium, and system further include generating a plurality of layer-specific image features at a plurality of layers of the image generation model, respectively. In some aspects, the image features are generated based on a plurality of reference images. In some aspects, the input prompt comprises a nonce token corresponding to the object. In some aspects, the image generation model is fine-tuned to generate images depicting the object based on the reference image.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 5.

Referring to FIG. 1, user 100 provides a text prompt and a reference image to image processing apparatus 110 via user device 105 and cloud 115. For example, the text prompt describes an object and a background scene “A beer can among wild flowers.” In some embodiments, the text prompt includes a nonce token that represents the trained object depicted in the reference image. For example, the text prompt may state “A S* among wild flowers.” For example, the nonce token “S*” represents the beer can depicted in the reference image. Additionally, the reference image that user 100 provided depicts the beer can stated by the text prompt. In response, image processing apparatus 110 generates a synthetic image that depicts the beer can from the reference image with a flower background. Image processing apparatus 110 displays the synthetic image and the text response to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 5. According to some aspects, image processing apparatus 110 includes a computer implemented network comprising a machine learning model, text encoder, a mask generation network, and an image generation model. Image processing apparatus 110 further includes a processor unit, a memory unit, an I/O module, and a training component. In some cases, the training component includes a data preparation component. In some embodiments, image processing apparatus 110 further includes a communication interface, user interface components, and a bus as described with reference to FIG. 11. Additionally, image processing apparatus 110 communicates with user device 105 and database 120 via cloud 115. Further detail regarding the operation of image processing apparatus 110 is provided with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including a reference image, an input prompt, and a ground-truth image. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for generating a synthetic image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a user (e.g., the user described with reference to FIG. 1) provides a text prompt and a reference image to the image processing apparatus (e.g., the image processing apparatus described with reference to FIGS. 1 and 5). For example, the text prompt describes “A beer can among wild flowers” and the reference image depicts the beer can. The image processing apparatus generates one or more image features based on the reference image using one or more attention layers of an image generation model. The image processing apparatus generates a synthetic image based on the text prompt and the image features. In one aspect, the synthetic image depicts the object (i.e., the beer can) depicted from the reference image and the background described by the text prompt.

At operation 205, the system provides a text prompt and a reference image. In some cases, the operations of this step refer to, or may be performed by, a user as described with reference to FIG. 1. For example, the user provides a text prompt and a reference image depicting a beer can to the image processing apparatus via a user interface provided by the image processing apparatus on a user device. In some cases, the text prompt describes a relationship between the object and a background scene. For example, the text prompt states “A beer can among wild flowers.” In some cases, a nonce token is used to represent the object in the text prompt. For example, the text prompt may state “A S* among wild flowers,” where the “S*” represents the object.

At operation 210, the system generates an image feature based on the reference image. In some cases, the operations of this step refer to, or may be performed by, an image processing apparatus as described with reference to FIGS. 1 and 5. In some cases, the operations of this step refer to, or may be performed by, an image generation model as described with reference to FIGS. 3, 5, 6, and 9. In some embodiments, the system generates an object mask based on the reference image. For example, the object mask indicates the location of the object within the reference image. The object mask is combined with the reference image as input to the image generation model to generate one or more image features. By using an object mask, the image generation model can accurately generate image features containing important information about the object and exclude information about the background region of the reference image.

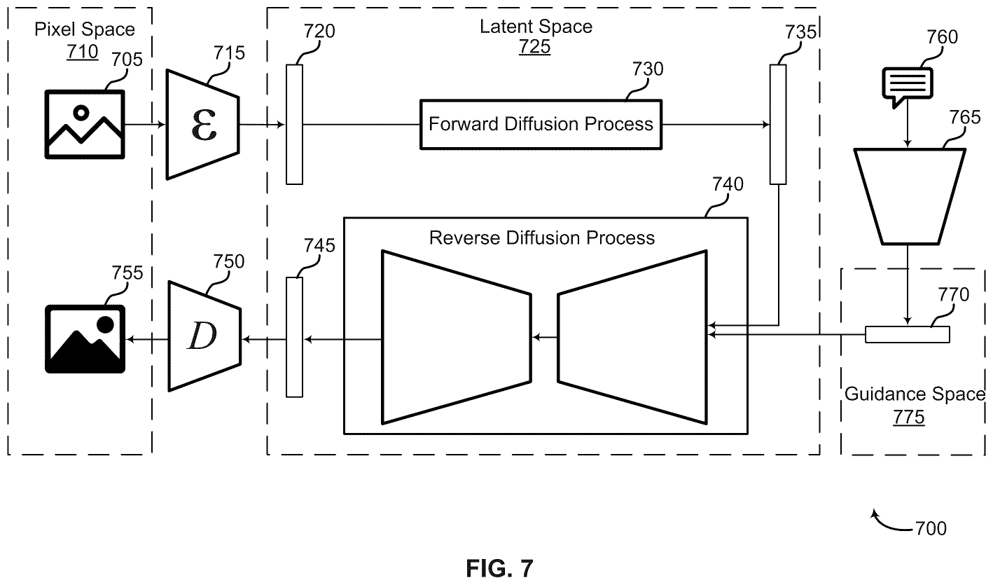

At operation 215, the system generates a synthetic image based on the text prompt and the image feature. In some cases, the operations of this step refer to, or may be performed by, an image processing apparatus as described with reference to FIGS. 1 and 5. In some cases, the operations of this step refer to, or may be performed by, an image generation model as described with reference to FIGS. 3, 5, 6, and 9. In some cases, the image generation model generates synthetic images based on a noise input and uses the text prompt and image features as guidance to guide the diffusion process of the image generation model. Further detail on the diffusion process is described with reference to FIG. 7.

At operation 220, the system displays the synthetic image. In some cases, the operations of this step refer to, or may be performed by, an image processing apparatus as described with reference to FIGS. 1 and 5. In some cases, the operations of this step refer to, or may be performed by, an image generation model as described with reference to FIGS. 3, 5, 6, and 9. In some cases, the synthetic image is displayed on a user device via a user interface of the image processing apparatus and cloud.

FIG. 3 shows an example of text-to-image generation according to aspects of the present disclosure. The example shown includes machine learning model 300, text prompt 305, reference image 310, image generation model 315, synthetic image 320, and conventional output image 325. In some embodiments, machine learning model 300 is implemented in a user interface, where a user can provide inputs such as text prompt 305 and reference image 310 to the user interface to generate synthetic image 320.

Referring to FIG. 3, image generation model 315 receives text prompt 305 and reference image 310 to generate synthetic image 320. For example, text prompt 305 states “A backpack in a frozen valley” and reference image 310 depicts the visual features of the backpack. In response, image generation model 315 generates synthetic image 320 depicting the same backpack (with fine details) from reference image 310 and the background described by text prompt 305. Compared to conventional output image 325, synthetic image 320 accurately depicts detailed features of the backpack from the reference image. For example, the stickers on the backpack in reference image 310 and the sticks on the backpack in synthetic image 320 are the same. Additionally, the backpack straps from reference image 310 and synthetic image 320 are the same. On the contrary, conventional output image 325 does not depict the fine details of the backpack.

Machine learning model 300 is an example of, or includes aspects of, the corresponding element described with reference to FIGS. 6 and 9. Text prompt 305 is an example of, or includes aspects of, the corresponding element described with reference to FIGS. 6, 7, and 9. Reference image 310 is an example of, or includes aspects of, the corresponding element described with reference to FIGS. 6 and 9.

Image generation model 315 is an example of, or includes aspects of, the corresponding element described with reference to FIGS. 5, 6, and 9. Synthetic image 320 is an example of, or includes aspects of, the corresponding element described with reference to FIGS. 6 and 9.

FIG. 4 shows an example of a method 400 for generating a synthetic image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system obtains an input prompt and a reference image depicting an object. In some cases, the operations of this step refer to, or may be performed by, an image generation model as described with reference to FIGS. 3, 5, 6, and 9. In some cases, for example, an input prompt refers to a text prompt including text or a set of instructions provided as input to a model to elicit an output. In some cases, the text prompt is used as guidance to guide an image generation model. For example, the text prompt includes text that describes the background of the synthetic image to be generated. In some cases, the reference image refers to an image used as data input to a model to guide the image generation model. In some cases, the image depicts an object, an element, a scene, a color, and/or a background.

At operation 410, the system generates, using an image generation model, image features for the object based on the reference image. In some cases, the operations of this step refer to, or may be performed by, an image generation model as described with reference to FIGS. 3, 5, 6, and 9. In some embodiments, one or more attention layers of the image generation model receive the reference image to generate one or more image features. In some embodiments, the image generation model generates layer-specific image features at each of the one or more attention layers. Then, each of the layer-specific image features is input to the corresponding attention layer of the image generation model to generate the synthetic image.

In some cases, image features refer to the characteristics or patterns within the reference image that are used to represent and capture important information. These image features can be easily processed by a machine learning model (e.g., an image generation model). In some cases, image features are represented as vectors or embeddings in a vector space.

At operation 415, the system generates, using the image generation model, a synthetic image depicting the object based on the input prompt and the image features from the reference image. In some cases, the operations of this step refer to, or may be performed by, an image generation model as described with reference to FIGS. 3, 5, 6, and 9. In some aspects, an attention layer in an image generation model focuses on different parts of the input image (e.g., the reference image) when generating or processing the images. The attention layer is able to assign varying levels of importance to different regions of the reference image and enables the image generation model to effectively capture intricate details and complex patterns of the reference image. As a result, the information contained in the image features can be used to generate high-resolution images.

### System Architecture

In FIGS. 5-8, an apparatus and system for image processing are described. The apparatus and system include at least one processor, at least one memory storing instructions executable by the at least one processor, and an image generation model comprising parameters stored in the at least one memory and trained to generate image features for an object depicted in a reference image and to generate a synthetic image depicting the object based on an input prompt and the image features, where the image generation model receives the image features via at least one attention layer.

According to some aspects, the image generation model comprises a diffusion U-Net. In some aspects, the image generation model receives the image features at a plurality of attention layers corresponding to a plurality of decoder layers of the diffusion U-Net. In some aspects, the at least one attention layer comprises a self-attention layer.

Some examples of the apparatus and system further include a mask generation network comprising parameters stored in the at least one memory and configured to generate an object mask that indicates the location of the object in the reference image. Some examples of the apparatus and system further include a text encoder comprising parameters stored in the at least one memory and configured to encode the input prompt.

FIG. 5 shows an example of an image processing apparatus 500 according to aspects of the present disclosure. The example shown includes image processing apparatus 500, processor unit 505, I/O module 510, memory unit 515, and training component 535. In one aspect, memory unit 515 includes text encoder 520, mask generation network 525, and image generation model 530.

According to some embodiments of the present disclosure, image processing apparatus 500 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 500 is an example of, or includes aspects of, the corresponding element described with reference to FIG. 1.

Processor unit 505 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 505 is configured to operate a memory array using a memory controller. In other cases, a memory controller is integrated into the processor. In some cases, processor unit 505 is configured to execute computer-readable instructions stored in a memory to perform various functions. In some embodiments, processor unit 505 includes special-purpose components for modem processing, baseband processing, digital signal processing, or transmission processing. Processor unit 505 is an example of, or includes aspects of, the processor described with reference to FIG. 11.

I/O module 510 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 510 includes a user interface. A user interface may enable a user to interact with a device. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 510 is an example of, or includes aspects of, the I/O interface described with reference to FIG. 11.

Examples of memory unit 515 include random access memory (RAM), read-only memory (ROM), or a hard disk. Examples of memory unit 515 include solid-state memory and a hard disk drive. In some examples, memory unit 515 is used to store computer-readable, computer-executable software including instructions that, when executed, cause a processor to perform various functions described herein.

In some cases, memory unit 515 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 515 store information in the form of a logical state.

In one aspect, memory unit 515 includes text encoder 520, mask generation network 525, and image generation model 530. In one aspect, memory unit 515 includes a machine learning model. Memory unit 515 is an example, of, or includes aspects of, the memory subsystem described with reference to FIG. 11.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 515 and executable by processor unit 505, as firmware, as one or more hardware circuits, or as a combination thereof.

According to some embodiments of the present disclosure, the machine learning model includes an artificial neural network (ANN), which is a hardware or a software component that includes a number of connected nodes (e.g., artificial neurons), that loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, the machine learning model includes machine learning parameters. Machine learning parameters, also known as model parameters or weights, are variables that provide behavior and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence), and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, which allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, text encoder 520 is a computational algorithm, model, or system designed to convert input text data into a numerical representation in the form of vectors or embeddings. The numerical representation is used for various natural language processing tasks, such as text classification and information retrieval. In some cases, the numerical representation captures meaningful information and relationships within the text in a format that can be easily processed by a machine learning model.

According to some aspects, text encoder 520 is implemented as software stored in memory unit 515 and executable by processor unit 505, as firmware, as one or more hardware circuits, or as a combination thereof. According to some aspects, the input prompt includes a nonce token corresponding to the object. According to some aspects, text encoder 520 comprises parameters stored in the at least one memory and configured to encode the input prompt. Text encoder 520 is an example of, or includes aspects of, the corresponding element described with reference to FIGS. 7 and 9.

According to some aspects, mask generation network 525 is implemented as software stored in memory unit 515 and executable by processor unit 505, as firmware, as one or more hardware circuits, or as a combination thereof. According to some aspects, mask generation network 525 generates an object mask that indicates a location of the object in the reference image. According to some aspects, mask generation network 525 comprises parameters stored in the at least one memory and configured to generate an object mask that indicates a location of the object in the reference image.

According to some aspects, image generation model 530 is implemented as software stored in memory unit 515 and executable by processor unit 505, as firmware, as one or more hardware circuits, or as a combination thereof. According to some aspects, image generation model 530 obtains an input prompt and a reference image depicting an object. In some examples, image generation model 530 generates image features for the object based on the reference image. In some examples, image generation model 530 generates a synthetic image depicting the object based on the input prompt and the image features, where the image generation model 530 is trained to receive the image features via at least one attention layer.

In some aspects, the synthetic image depicts the object in a scene described by the input prompt. In some aspects, the image features are conditioned based on a diffusion time-step. In some examples, image generation model 530 generates a set of layer-specific image features at a set of layers of the image generation model 530, respectively, where the set of layer-specific image features are provided to the set of layers as input. In some aspects, the image features are generated based on a set of reference images. In some aspects, the image generation model 530 is trained using the reference image.

In some aspects, the image generation model 530 is pre-trained in a first training phase without receiving image features at the at least one attention layer and fine-tuned in a second training phase to receive the image features at the at least one attention layer. In some aspects, each layer of the image generation model 530 is updated during the second training phase. In some aspects, the at least one attention layer receives a different number of input tokens during the first training phase and the second training phase. In some aspects, the image generation model 530 is trained to receive layer-specific image features for the object at a set of different layers.

According to some aspects, image generation model 530 comprises parameters stored in the at least one memory and trained to generate image features for an object depicted in a reference image and to generate a synthetic image depicting the object based on an input prompt and the image features, wherein the image generation model 530 receives the image features via at least one attention layer. In some aspects, the image generation model 530 includes a diffusion U-Net. In some aspects, the image generation model 530 receives the image features at a set of attention layers corresponding to a set of decoder layers of the diffusion U-Net. In some aspects, the at least one attention layer includes a self-attention layer. Image generation model 530 is an example of, or includes aspects of, the corresponding element described with reference to FIGS. 3, 6, and 9. Image generation model 530 is an example of, or includes aspects of, the diffusion model described with reference to FIG. 7.

According to some aspects, training component 535 is implemented as software stored in memory unit 515 and executable by processor unit 505, as firmware, as one or more hardware circuits, or as a combination thereof. In one aspect, training component 535 includes a data generation component, where the data generation component creates a training set to train the machine learning model.

According to some embodiments, training component 535 is implemented as software stored in a memory unit and executable by a processor in a processor unit of a separate computing device, as firmware in a separate computing device, as one or more hardware circuits of the separate computing device, or as a combination thereof. In some examples, training component 535 is part of another apparatus other than image processing apparatus 500 and communicates with the image processing apparatus 500. In some examples, training component 535 is part of image processing apparatus 500.

According to some aspects, training component 535 obtains a training set including a reference image depicting an object, an input prompt, and a ground-truth image. In some examples, training component 535 initializes image generation model 530. In some examples, training component 535 trains, using the training set, the image generation model 530 to generate image features for the object based on the reference image and to generate a synthetic image depicting the object based on the input prompt and the image features, where the image generation model 530 receives the image features via at least one attention layer. In some examples, training component 535 computes a diffusion loss. In some examples, training component 535 updates parameters of the image generation model 530 based on the computed diffusion loss.

FIG. 6 shows an example of a machine learning model 600 according to aspects of the present disclosure. The example shown includes machine learning model 600, text prompt 605, noise input 610, image generation model 615, reference image 620, object mask 625, image feature 630, and synthetic image 635.

Referring to FIG. 6, image generation model 615 receives text prompt 605, noise input 610, reference image 620, and object mask 625 to generate synthetic image 635. In some embodiments, text prompt 605 and reference image 620 are user inputs and noise input 610 and object mask 625 are system-generated inputs obtained from machine learning model 600. For example, text prompt 605 states “A beer can among wild flowers” and reference image 620 depicts a beer can. In some cases, reference image 620 is used during training to train image generation model 615. In some embodiments, text prompt 605 may include a nonce token “S*” that indicates the object depicted in reference image 620 learned during the training stage. For example, text prompt 605 may state “A S* among wild flowers.”

In some aspects, image generation model 615 includes a diffusion model (e.g., the diffusion model described with reference to FIG. 7). Image generation model 615 takes noise input 610 (e.g., a noise map) and iteratively removes noise by performing reverse diffusion to generate synthetic image 635. In some cases, text prompt 605 is used to guide the diffusion model, where synthetic image 635 includes an element described by text prompt 605. In some cases, other features such as image feature 630 from reference image 620 can be used for the image generation. Further detail on reverse diffusion is described with reference to FIG. 7.

According to some embodiments, image generation model 615 generates an image feature 630 (or one or more layer-specific image features) based on reference image 620 and object mask 625. For example, a mask generation network is used to generate object mask 625 indicating the location of the object in reference image 620. By using object mask 625 as input, image generation model 615 can accurately and efficiently generate the image feature 630 for reference image 620. For example, object mask 625 allows image generation model 615 to attend to the object depicted in reference image 620 rather than other regions (such as the background) of reference image 620. As a result, less time is needed to generate the image feature 630, and accurate visual information in image feature 630 can be obtained.

According to some embodiments, image generation model 615 receives the image feature 630 as input to one or more attention layers of image generation model 615 for the image generation process. For example, the attention layers enable machine learning model 600 (including image generation model 615) to capture intricate details and complex patterns of reference image 620 and generate synthetic image 635 having the same intricate details and complex patterns. In some cases, an attention layer includes a self-attention layer that routes information from every spatial location in an image (e.g., reference image 620) to every other. According to some embodiments, the self-attention layer is trained to learn information from spatial locations in the training images (e.g., reference image 620) to pass information to regions in synthetic image 635 where the desired object is to be generated.

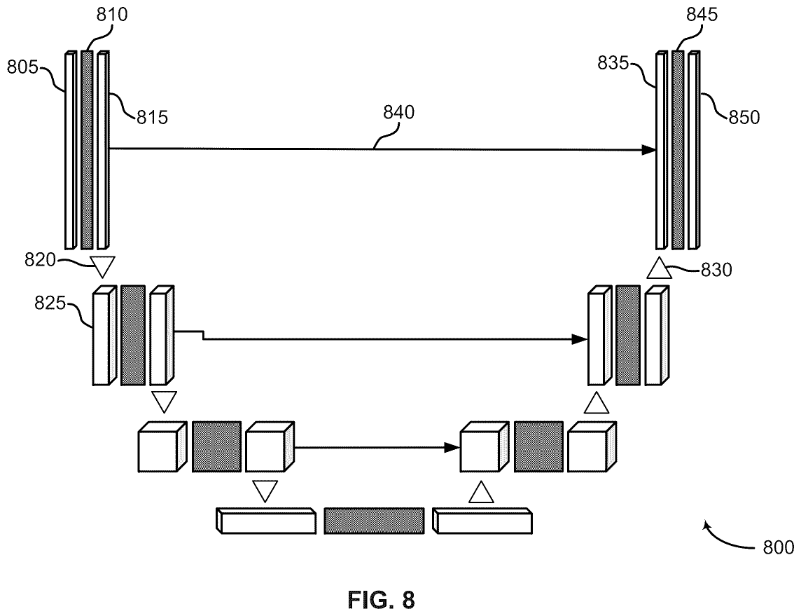

According to some aspects, image generation model 615 includes a diffusion U-Net architecture, where the U-Net is used to extract the image feature 630 from reference image 620. In some cases, the image feature 630 is aligned with the generation process before initiating the training process. For each self-attention layer in the decoder (or neural network layers in the up-sampling process) of the U-Net, the image feature 630 from the K and V (key and value representations, respectively) are stored and concatenated during the generation process. Further detail on U-Net is described with reference to FIGS. 7 and 8.

In some embodiments, the same diffusion timestep T is used during feature extraction of K and V representations and during image generation. For example, by extracting a different set of K and V values from reference image 620 for each generation timestep T, where T≠0, significant image quality can be improved. In some cases, when timestep Tis set to 0, no noise is applied to reference image 620. By applying the image features to all layers of the decoder in U-Net, image generation model 615 can generate synthetic image 635 having the highest image quality.

Machine learning model 600 is an example of, or includes aspects of, the corresponding element described with reference to FIGS. 3 and 9. Text prompt 605 is an example of, or includes aspects of, the corresponding element described with reference to FIGS. 3, 7, and 9. Noise input 610 is an example of, or includes aspects of, the corresponding element described with reference to FIG. 9.

Image generation model 615 is an example of, or includes aspects of, the corresponding element described with reference to FIGS. 3, 5, and 9. Reference image 620 is an example of, or includes aspects of, the corresponding element described with reference to FIGS. 3 and 9. Object mask 625 is an example of, or includes aspects of, the corresponding element described with reference to FIG. 9. Synthetic image 635 is an example of, or includes aspects of, the corresponding element described with reference to FIGS. 3 and 9.

FIG. 7 shows an example of an image generation model according to aspects of the present disclosure. The example shown includes diffusion model 700, original image 705, pixel space 710, image encoder 715, original image feature 720, latent space 725, forward diffusion process 730, noisy feature 735, reverse diffusion process 740, denoised image feature 745, image decoder 750, output image 755, text prompt 760, text encoder 765, guidance feature 770, and guidance space 775.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 700 may take an original image 705 in a pixel space 710 as input and apply an image encoder 715 to convert original image 705 into original image feature 720 in a latent space 725. Then, a forward diffusion process 730 gradually adds noise to the original image feature 720 to obtain noisy feature 735 (also in latent space 725) at various noise levels.

Next, a reverse diffusion process 740 (e.g., a U-Net ANN) gradually removes the noise from the noisy feature 735 at the various noise levels to obtain the denoised image feature 745 in latent space 725. In some examples, denoised image feature 745 is compared to the original image feature 720 at each of the various noise levels, and parameters of the reverse diffusion process 740 of the diffusion model are updated based on the comparison. Finally, an image decoder 750 decodes the denoised image feature 745 to obtain an output image 755 in pixel space 710. In some cases, an output image 755 is generated at each of the various noise levels. The output image 755 can be compared to the original image 705 to train the reverse diffusion process 740. In some cases, output image 755 refers to the synthetic image (e.g., described with reference to FIGS. 3, 6, and 9).

In some cases, image encoder 715 and image decoder 750 are pre-trained prior to training the reverse diffusion process 740. In some examples, image encoder 715 and image decoder 750 are trained jointly, or the image encoder 715 and image decoder 750 are fine-tuned jointly with the reverse diffusion process 740.

The reverse diffusion process 740 can also be guided based on a text prompt 760, or another guidance prompt, such as an image, a layout, a style, a color, a segmentation map, etc. The text prompt 760 can be encoded using a text encoder 765 (e.g., a multimodal encoder) to obtain guidance feature 770 in guidance space 775. The guidance feature 770 can be combined with the noisy feature 735 at one or more layers of the reverse diffusion process 740 to ensure that the output image 755 includes content described by the text prompt 760. For example, guidance feature 770 can be combined with the noisy feature 735 using a cross-attention block within the reverse diffusion process 740. In some cases, text prompt 760 refers to the corresponding element described with reference to FIGS. 3, 6, and 9.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having the same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt (e.g., text prompt 760) describing content to be included in a generated image. For example, a user may provide the prompt “I want to generate something creative with this person, with painting style of Van Gough, can you help me?” In some examples, guidance can be provided in a form other than text, such as via an image, a sketch, a color, a style, or a layout. The system converts text prompt 760 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 700 generates an image based on the noise map and the conditional guidance vector.

A diffusion process can include both a forward diffusion process 730 for adding noise to an image (e.g., original image 705) or features (e.g., original image feature 720) in a latent space 725 and a reverse diffusion process 740 for denoising the images (or features) to obtain a denoised image (e.g., output image 755). The forward diffusion process 730 can be represented as q(xₜ|xₜ₋₁), and the reverse diffusion process 740 can be represented as p(xₜ₋₁|xₜ). In some cases, the forward diffusion process 730 is used during training to generate images with successively greater noise, and a neural network is trained to perform the reverse diffusion process 740 (e.g., to successively remove the noise).

In an example forward diffusion process 730 for a latent diffusion model (e.g., diffusion model 700), the diffusion model 700 maps an observed variable x₀ (either in a pixel space 710 or a latent space 725) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 740. During the reverse diffusion process 740, the diffusion model 700 begins with noisy data x_{T}, such as a noisy image and denoises the data to obtain the p(xₜ₋₁|xₜ). At each step t−1, the reverse diffusion process 740 takes xₜ, such as the first intermediate image, and t as input. Here, t represents a step in the sequence of transitions associated with different noise levels, The reverse diffusion process 740 outputs xₜ₋₁, such as the second intermediate image iteratively until x_{T} is reverted back to x₀, the original image 705. The reverse diffusion process 740 can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0,I) is the pure noise distribution as the reverse diffusion process 740 takes the outcome of the forward diffusion process 730, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x, in a pixel space can be mapped into a latent space 725 as input and a generated data \tilde{x} is mapped back into the pixel space 710 from the latent space 725 as output. In some examples, x₀ represents an original input image with low image quality, latent variables x₁, . . . , x_{T} represent noisy images, and \tilde{x} represents the generated image with high image quality.

A diffusion model 700 may be trained using both a forward diffusion process 730 and a reverse diffusion process 740. In one example, the user initializes an untrained model. Initialization can include establishing the architecture of the model and establishing initial values for the model parameters. In some cases, the initialization can include setting hyper-parameters such as the number of layers, the resolution and channels of each layer block, the location of skip connections, and the like.

The system then adds noise to a training image using a forward diffusion process 730 in N stages. In some cases, the forward diffusion process 730 is a fixed process where Gaussian noise is successively added to an image. In latent diffusion models, the Gaussian noise may be successively added to features (e.g., original image feature 720) in a latent space 725.

At each stage n, starting with stage N, a reverse diffusion process 740 is used to predict the image or image features at stage n−1. For example, the reverse diffusion process 740 can predict the noise that was added by the forward diffusion process 730, and the predicted noise can be removed from the image to obtain the predicted image. In some cases, an original image 705 is predicted at each stage of the training process.

The training component (e.g., training component described with reference to FIG. 7) compares predicted image (or image features) at stage n−1 to an actual image (or image features), such as the image at stage n−1 or the original input image. For example, given observed data x, the diffusion model 700 may be trained to minimize the variational upper bound of the negative log-likelihood −log p_{θ}(x) of the training data. The training component then updates parameters of the diffusion model 700 based on the comparison. For example, parameters of a U-Net may be updated using gradient descent. Time-dependent parameters of the Gaussian transitions can also be learned. Further detail on U-Net is described with reference to FIG. 8.

Text prompt 760 is an example of, or includes aspects of, the corresponding element described with reference to FIGS. 3, 6, and 9. Text encoder 765 is an example of, or includes aspects of, the corresponding element described with reference to FIGS. 5 and 9.

FIG. 8 shows an example of a U-Net 800 according to aspects of the present disclosure. The example shown includes U-Net 800, input feature 805, initial neural network layer 810, intermediate feature 815, down-sampling layer 820, down-sampled feature 825, up-sampling process 830, up-sampled feature 835, skip connection 840, final neural network layer 845, and output feature 850.

Referring to FIG. 8, U-Net 800 depicted is an example of, or includes aspects of, the architecture used within the reverse diffusion process described with reference to FIG. 7. In some examples, diffusion models are based on a neural network architecture known as a U-Net. The U-Net 800 takes input feature 805 having an initial resolution and an initial number of channels and processes the input feature 805 using an initial neural network layer 810 (e.g., a convolutional network layer) to produce intermediate feature 815. The intermediate feature 815 is then down-sampled using a down-sampling layer 820 such that the down-sampled feature 825 has a resolution less than the initial resolution and a number of channels greater than the initial number of channels.

This process is repeated multiple times, and then the process is reversed. In some cases, this reversed process is called a decoding process. For example, the down-sampled feature 825 is up-sampled using up-sampling process 830 to obtain up-sampled feature 835. In some cases, the down-sampled feature 825 is obtained using an intermediate neural network layer (e.g., a self-attention layer).

In some aspects, a self-attention layer is a mechanism in neural networks that enables each element in a sequence to attend to a different part of the same sequence, allowing the model to weigh the importance of different elements when processing information. In some cases, the self-attention layer allows the machine learning model to focus on different spatial locations within an image when processing information. For example, the self-attention layer captures the dependencies and relationships between pixels within the image and captures intricate details and complex patterns of an important region of the image.

The up-sampled feature 835 can be combined with intermediate feature 815 having the same resolution and number of channels via a skip connection 840. These inputs are processed using a final neural network layer 845 to produce output feature 850. In some cases, the output feature 850 has the same resolution as the initial resolution and the same number of channels as the initial number of channels.

In some cases, U-Net 800 takes additional input features to produce conditionally generated output. For example, the additional input features could include a vector representation of an input prompt. In some cases, for example, the additional input feature includes the one or more image features generated, using the image generation model, based on the reference image. The additional input features can be combined with the intermediate feature 815 within the neural network at one or more layers. For example, a cross-attention module can be used to combine the additional input features and the intermediate feature 815.

According to some embodiments, the image generation model (e.g., the image generation model described with reference to FIGS. 3, 5-7, and 9) generates image features based on the reference image and the object mask. In some cases, the image features include a plurality of layer-specific image features. Each of the layer-specific image features is combined with the each of the corresponding decoding layers (e.g., the neural network layers in the up-sampling process 830) of the U-Net 800. In some cases, the image features (which include visual information of the object depicted in the reference image) is combined with the features (which includes the information of the text prompt). For example, the two types of features are combined using cross-attention, concatenation, convolution operations, or a combination thereof. Further detail on combining the features is described with reference to FIG. 8.

FIG. 9 shows an example of data flow in an image processing system according to aspects of the present disclosure. The example shown includes machine learning model 900, text prompt 905, text encoder 910, text embedding 915, noise input 920, image generation model 925, reference image 930, object mask 935, image feature 940, and synthetic image 945.

Referring to FIG. 9, text prompt 905 and reference image 930 are provided to machine learning model 900 to generate synthetic image 945. In one aspect, machine learning model 900 includes text encoder 910 and image generation model 925. According to some embodiments, text encoder 910 receives text prompt 905 to generate text embedding 915. In some cases, an embedding is a numerical representation of words, sentences, documents, or images in a vector space. The embedding is used to encode semantic meaning, relationships, and context of the words, sentences, documents, or images where the encoding can be processed by a machine learning model. For example, an image embedding captures complex visual features in a high-dimensional vector space. For example, a text embedding (e.g., text embedding915) includes semantic relationships between words or tokens in a low-dimensional vector space.

In some embodiments, reference image 930 and object mask 935 are provided to image generation model 925, and image generation model 925 generate image feature 940 based on reference image 930 and object mask 935. For example, object mask 935 is obtained from a mask generation network including a saliency prediction model. In some cases, the saliency prediction model identifies an area of interest and labels the area of interest as white. For example, the area of interest is an object depicted in reference image 930. In some cases, the object may be described (or partially described) by the text prompt. Then, the saliency prediction model labels the remaining region as black. In one aspect, the object mask 935 is a black-and-white image indicating the object from reference image 930. In one aspect, object mask 935 identifies a location and/or shape of an object in reference image 930.

According to some embodiments, image generation model 925 generates one or more image features based on reference image 930 and object mask 935. For example, image feature 940 may include layer-specific image features at a plurality of decoding layers (or upsampling process of the U-Net described with reference to FIG. 8) of image generation model 925. In some cases, the layer-specific image features of reference image 930 are respectively added to each of the image features of the text embedding 915 and noise input 920 of the corresponding decoding layers of image generation model 925.

In some embodiments, image generation model 925 takes text embedding 915, noise input 920, and image feature 940 as input. For example, machine learning model 900 provides noise input 920 to image generation model 925. In one aspect, noise input 920 includes a noise map. In some embodiments, noise input 920 is used to initiate the diffusion process in image generation model 925. Then, text embedding 915 and image feature 940 are concatenated to one or more attention layers of a U-Net within image generation model 925 to guide the diffusion process. Accordingly, image generation model 925 generates synthetic image 945. Further detail on U-Net is described with reference to FIG. 8. Further detail on combining the features is described with reference to FIG. 8.

Machine learning model 900 is an example of, or includes aspects of, the corresponding element described with reference to FIGS. 3 and 6. Text prompt 905 is an example of, or includes aspects of, the corresponding element described with reference to FIGS. 3, 6, and 7. Text encoder 910 is an example of, or includes aspects of, the corresponding element described with reference to FIGS. 5 and 7. Noise input 920 is an example of, or includes aspects of, the corresponding element described with reference to FIG. 6.

Image generation model 925 is an example of, or includes aspects of, the corresponding element described with reference to FIGS. 3, 5, and 6. Reference image 930 is an example of, or includes aspects of, the corresponding element described with reference to FIGS. 3 and 6. Object mask 935 is an example of, or includes aspects of, the corresponding element described with reference to FIG. 6. Synthetic image 945 is an example of, or includes aspects of, the corresponding element described with reference to FIGS. 3 and 6.

### Training and Evaluation

In FIG. 10, a method, apparatus, non-transitory computer readable medium, and system for image processing are described. The method, apparatus, non-transitory computer readable medium, and system include obtaining a training set including a reference image depicting an object, an input prompt, and a ground-truth image and training, using the training set, the image generation model to generate image features for the object based on the reference image and to generate a synthetic image depicting the object based on the input prompt and the image features.

In some aspects, the image generation model is pre-trained in a first training phase without receiving the image features at an attention layer and fine-tuned in a second training phase to receive the image features at the attention layer. In some aspects, each layer of the image generation model is updated during the second training phase. In some aspects, the attention layer receives a different number of input tokens during the first training phase and the second training phase.

Some examples of the method, apparatus, non-transitory computer readable medium, and system further include computing a diffusion loss. Some examples further include updating parameters of the image generation model based on the diffusion loss. In some aspects, the image generation model is trained to receive layer-specific image features for the object at a plurality of different layers.

FIG. 10 shows an example of a method 1000 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system obtains a training set including a reference image depicting an object, an input prompt, and a ground-truth image. In some cases, the operations of this step refer to, or may be performed by, a training component as described with reference to FIG. 5. In some embodiments, for example, the reference image is used during inference and training. In some cases, the ground-truth image includes an element described by the input prompt and an object from the reference image.

In some embodiments, the system initializes an image generation model. In some cases, a training component (e.g., the training component described with reference to FIG. 5.) initializes the image generation model. Initialization can include establishing the architecture of the model and initial values for the model parameters. In some cases, the initialization can include setting hyper-parameters such as the number of layers, the resolution and channels of each layer block, the location of skip connections, and the like.

At operation 1010, the system trains, using the training set, the image generation model to generate image features for the object based on the reference image and to generate a synthetic image depicting the object based on the input prompt and the image features, where the image generation model receives the image features via at least one attention layer. In some cases, the operations of this step refer to, or may be performed by, a training component as described with reference to FIG. 5.

In some embodiments, during training, all parameters of the U-Net of the image generation model are updated. For example, the training component calculates a diffusion loss based on the synthetic image and the ground-truth image and updates the image generation model based on the diffusion loss. In some embodiments, key and value representation in the attention mechanism of attention layers are concatenated in the corresponding attention layers.

### Computing Device

FIG. 11 shows an example of a computing device 1100 according to aspects of the present disclosure. The example shown includes computing device 1100, processor 1105, memory subsystem 1110, communication interface 1115, I/O interface 1120, user interface component 1125, and channel 1130.

In some embodiments, computing device 1100 is an example of, or includes aspects of, the image processing apparatus described with reference to FIGS. 1 and 5. In some embodiments, computing device 1100 includes processor 1105 that can execute instructions stored in memory subsystem 1110 to obtain an input prompt and a reference image depicting an object, generate image features for the object based on the reference image, and generate a synthetic image depicting the object based on the input prompt and the image features, where an image generation model is trained to receive the image features via at least one attention layer.

According to some embodiments, processor 1105 includes one or more processors. In some cases, processor 1105 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1105 is configured to operate a memory array using a memory controller. In other cases, a memory controller is integrated into processor 1105. In some cases, processor 1105 is configured to execute computer-readable instructions stored in a memory to perform various functions. In some embodiments, processor 1105 includes special-purpose components for modem processing, baseband processing, digital signal processing, or transmission processing. Processor 1105 is an example of, or includes aspects of, the processor unit described with reference to FIG. 5.

According to some embodiments, memory subsystem 1110 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1110 is an example of, or includes aspects of, the memory unit described with reference to FIG. 5.

According to some embodiments, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1115.

According to some embodiments, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or hardware components controlled by the I/O controller. I/O interface 1120 is an example of, or includes aspects of, the I/O module described with reference to FIG. 5.

According to some embodiments, user interface component 1125 enables a user to interact with computing device 1100. In some cases, user interface component 1125 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over existing technology (e.g., conventional image generation models). Example experiments demonstrate that the image processing apparatus based on the present disclosure outperforms conventional image generation models. Details on the example use cases based on embodiments of the present disclosure are described with reference to FIG. 3.

The description and drawings described herein represent example configurations and do not represent all the implementations within the scope of the invention. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

1. A method comprising:
obtaining a reference image an input prompt describing an image element;
identifying an object from the reference image;
generating, using an image generation model, image features representing the object based on the reference image; and
generating, using the image generation model, a synthetic image depicting the image element and the object based on the input prompt and the image features from the reference image.

2. The method of claim 1, wherein:
the reference image depicts the object in a first scene and the synthetic image depicts the object in a second scene described by the input prompt.

3. The method of claim 1, wherein generating the image features comprises:
generating an object mask that indicates a location of the object in the reference image, wherein the image features are generated based on the object mask.

4. The method of claim 1, wherein:
the input prompt describes a location of the object in the reference image, wherein generating the image features comprises determining the location of the object based on the input prompt, and wherein the image features are generated based on the location of the object.

5. The method of claim 1, wherein generating the image features comprises:
generating a plurality of layer-specific image features at a plurality of layers of the image generation model, respectively.

6. The method of claim 1, wherein:
the image features are generated based on a plurality of reference images.

7. The method of claim 1, wherein:
the input prompt comprises a nonce token corresponding to the object.

8. The method of claim 1, wherein:
the image generation model is fine-tuned to generate images depicting the object based on the reference image.

9. A method of training an image generation model, comprising:
obtaining a training set including a reference image depicting an object, an input prompt describing an image element, and a ground-truth image depicting the object and the image element; and
training, using the training set, the image generation model to generate image features for the object based on the reference image and to generate a synthetic image depicting the object based on the input prompt and the image features.

10. The method of claim 9, wherein:
the image generation model is pre-trained in a first training phase without receiving the image features at an attention layer and fine-tuned in a second training phase to receive the image features at the attention layer.

11. The method of claim 10, wherein:
each layer of the image generation model is updated during the second training phase.

12. The method of claim 10, wherein:
the attention layer receives a different number of input tokens during the first training phase and the second training phase.

13. The method of claim 9, wherein training the image generation model comprises:
computing a diffusion loss; and
updating parameters of the image generation model based on the diffusion loss.

14. The method of claim 9, wherein:
the image generation model is trained to receive layer-specific image features for the object at a plurality of different layers.

15. An apparatus comprising:
at least one processor;
at least one memory storing instructions executable by the at least one processor; and
an image generation model comprising parameters stored in the at least one memory and trained to generate image features for an object depicted in a reference image and to generate a synthetic image depicting the object based on an input prompt and the image features, wherein the image generation model receives the image features via an attention layer.

16. The apparatus of claim 15, wherein:
the image generation model comprises a diffusion U-Net.

17. The apparatus of claim 16, wherein:
the image generation model receives the image features at a plurality of attention layers corresponding to a plurality of decoder layers of the diffusion U-Net.

18. The apparatus of claim 15, further comprising:
a mask generation network configured to generate an object mask that indicates a location of the object in the reference image.

19. The apparatus of claim 15, further comprising:
a text encoder configured to encode the input prompt.

20. The apparatus of claim 15, wherein:
the attention layer comprises a self-attention layer.
